(19) United States
(12) Patent Application Publication
(10) Pub. No.: US 2014/0176700 A1
(43) Pub. Date: Jun. 26, 2014

(54) DRIVING ASSISTANT SYSTEM AND METHOD

(71) Applicants: HON HAI PRECISION INDUSTRY CO., LTD., New Taipei (TW); HONG FU JIN PRECISION INDUSTRY (ShenZhen) CO. LTD., Shenzhen (CN)

(72) Inventor: KANG-BIN WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/963,178

(22) Filed: Aug. 9, 2013

(30) Foreign Application Priority Data
Dec. 22, 2012 (CN) 2012105617723

(51) Int. Cl. H04N 5/232; B60R 11/04

(52) U.S. Cl. CPC H04N 5/23238; B60R 11/04
USPC 348/118

(57) ABSTRACT

A driving assistant system comprises a plurality of cameras configured to capture images around a vehicle, a monitor capable of displaying the images, and a Field-Programmable Gate Array (FPGA) connected to the plurality of cameras. The plurality of cameras comprising a first camera attached to a front central portion of the vehicle, a second camera attached to a first rearview mirror of the vehicle, a third camera attached to a second rearview mirror of the vehicle, and a fourth camera attached to a rear central portion of the vehicle. The FPGA is capable of combining the images into a panorama image and sending the panorama image to the monitor which displays the panorama image. The present disclosure further discloses a driving assistant method based upon the above driving assistant system.

### CROSS-REFERENCE TO RELATED APPLICATIONS

This application are related to co-pending application entitled, “DRIVING ASSISTANT SYSTEM AND METHOD”, filed on ***, application No. ***, (Atty. Docket No. US48635), and “DRIVING ASSISTANT SYSTEM AND METHOD”, filed on ***, application No. ***, (Atty. Docket No. US48637).

### BACKGROUND

1. Technical Field

The present disclosure relates to a driving assistant system and method.

2. Description of Related Art

For safety while driving of automotive vehicles, a small camera is mounted on a vehicle and directed to a specific direction to take an image not directly viewed by a driver's eye. The taken image is displayed on a monitor of the vehicle. However, the camera can not take images surrounding each side of the vehicle and blind spots still exist.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a driving assistant system.

FIG. 2 illustrates mounting positions of four cameras of the driving assistant system of FIG. 1.

FIG. 3 illustrates a flow chart of an embodiment of a driving assistant method.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean “at least one.”

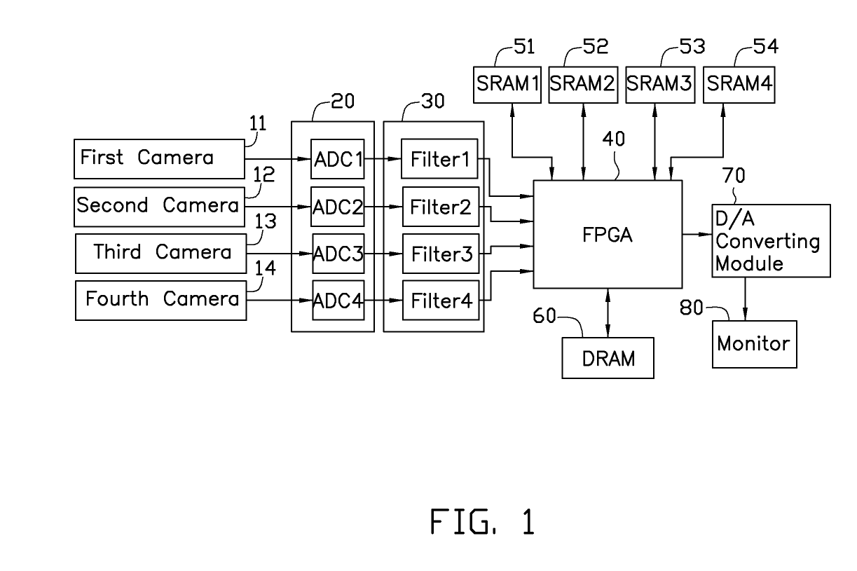

FIG. 1 shows an embodiment of a driving assistant system comprising a plurality of cameras, an analog-to-digital (A/D) converting module 20, a filter module 30, a Field-Programmable Gate Array (FPGA) 40, a digital-to-analog (D/A) converting module 70, and a monitor 80. The plurality of cameras comprises a first camera 11, a second camera 12, a third camera 13, and a fourth camera 14. A first Static Random Access Memory (SRAM) 51, a second SRAM 52, a third SRAM 53, and a third SRAM are connected to the FPGA 40 to store static data for the FPGA 40. A Dynamic Random Access memory (DRAM) 60 is connected to the FPGA 40 to store dynamic data for the FPGA 40.

The AD converting module 20 comprises a first AD converter ADC1connected to the first camera 11, a second AD converter ADC2 connected to the second camera 12, a third AD converter ADC3 connected to the third camera 13, and a fourth AD converter ADC4 connected to the fourth camera 14. The filter module 30 comprises a first filter connected to the first AD converter ADC1, a second filter connected to the second AD converter ADC2, a third filter connected to the third AD converter ADC3, and a fourth filter connected to the fourth AD converter ADC4. An output terminal of each of the first filter, the second filter, the third filter, and the fourth filter is connected to the FPGA 40. The D/A converting module 70 is connected to the FPGA 40. The monitor 80 is connected to the D/A converting module 80.

In one embodiment, each of the first A/D converter ADC1, the second A/D converter ADC2, the third A/D converter ADC3, and the fourth A/D converter ADC4 is a TVP5150 chip. Each of the first filter, the second filter, the third filter, and the fourth filter is a MDIN221 chip.

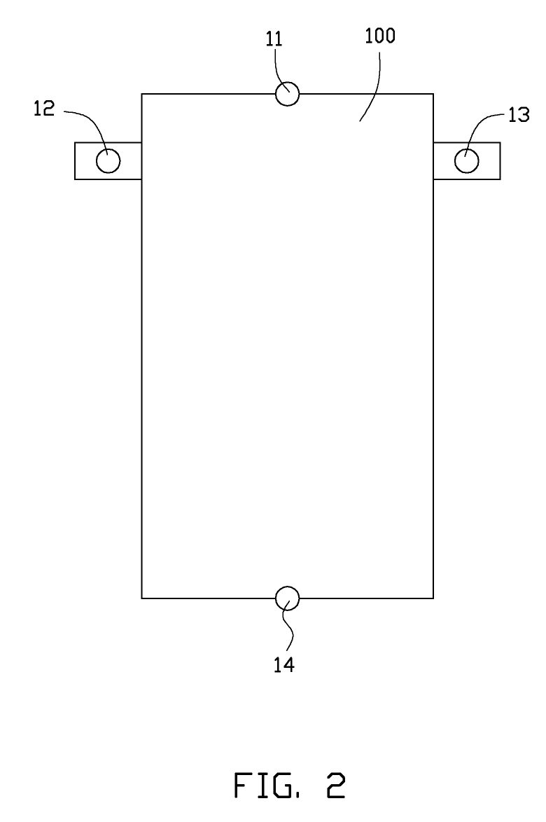

FIG. 2 shows mounting positions of the first camera 11, a second camera 12, a third camera 13, and a fourth camera 14. In one embodiment, the first camera 11 is attached to a front central portion of a vehicle 100. The second camera 12 and the third camera 13 are attached to two rearview mirrors of the vehicle. The fourth camera 14 is attached to a rear central portion of the vehicle 100. Each of the plurality of cameras is a wide-angle lens infrared camera (e.g., 170 degrees lens). The plurality of cameras can takes images around the vehicle, thus virtually eliminating blind spots around the vehicle.

Each of the plurality of cameras comprises a fish-eye lens to capture a fish-eye image around the vehicle 100. The fish-eye image comprises analog picture signals which carry information of the fish-eye image. The A/D converting module 20 converts analog picture signals to digital picture signals correspondingly. The digital picture signals is filtered by the filter module 30 and sent to the FPGA 40. The FPGA 40 converts the digital picture signals indicative of the fish-eye image into converted digital picture signals indicative of a plane image. Thus, the fish-eye image can be converted to the plane image. The FPGA 40 combines the converted digital picture signals coming from the plurality of cameras to get a panorama image which provides a 360° view around the vehicle 100. The combined digital picture signals are converted to analog picture signals by the D/A converting module 70 and sent to the monitor 80. The monitor 80 displays the panorama image.

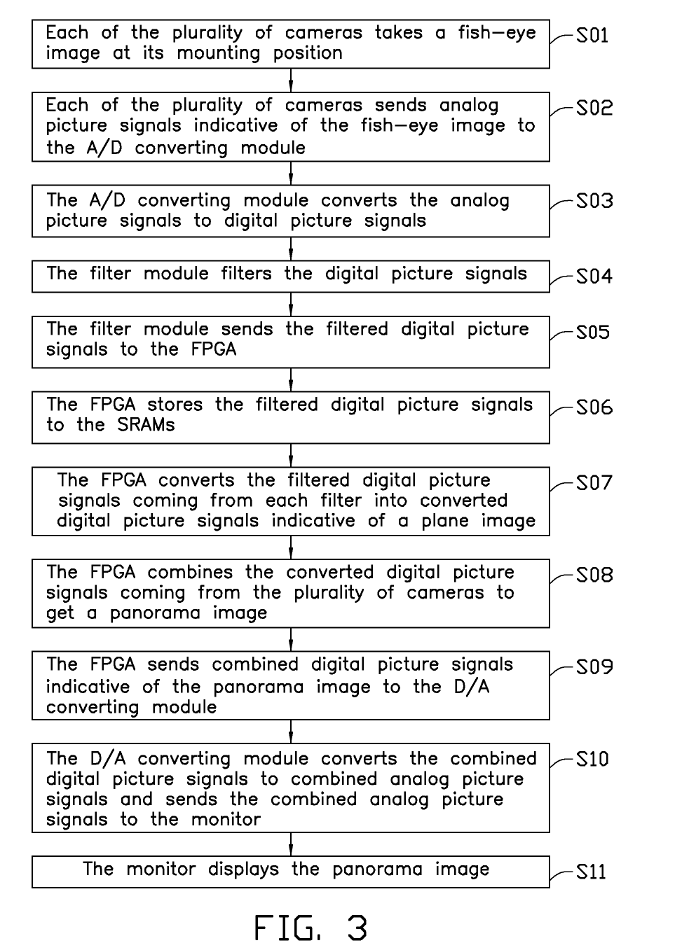

FIG. 3 shows a flow chart of an embodiment of a driving assistant method based upon the above driving assistant system. The driving assistant method comprises the following blocks.

In block S01, each of the plurality of cameras takes a fish-eye image at its mounting position.

In block S02, each of the plurality of cameras sends analog picture signals indicative of the fish-eye image to the A/D converting module 20. In particularly, analog picture signals coming from the first camera 11 are sent to the first AD converter ADC1.Analog picture signals coming from the second camera 12 are sent to the second AD converter ADC2. Analog picture signals coming from the third camera 13 are sent to the third AD converter ADC3. Analog picture signals coming from the fourth camera 14 are sent to the fourth AD converter ADC4.

In block S03, the A/D converting module 20 converts the analog picture signals to digital picture signals. In particularly, the first AD converter ADC1 converts the analog pictures signals coming from the first camera 11 to digital picture signals. The second AD converter ADC2 converts the analog pictures signals coming from the second camera 12 to digital picture signals. The third AD converter ADC3 converts the analog pictures signals coming from the third camera 13 to digital picture signals. The fourth AD converter ADC4 converts the analog pictures signals coming from the fourth camera 14 to digital picture signals.

In block S04, the filter module 30 filters the digital picture signals. In particularly, the first filter filters the digital picture signals coming from the first AD converter ADC1. The second filter filters the digital picture signals coming from the second AD converter ADC2. The third filter filters the digital picture signals coming from the third AD converter ADC3. The fourth filter filters the digital picture signals coming from the fourth AD converter ADC∝4.

In block S05, the filter module 30 sends the filtered digital picture signals to the FPGA 40.

In block S06, the FPGA 40 stores the filtered digital picture signals to the first SRAM 51, the second SRAM 52, the third SRAM 53, and the fourth SRAM 54. In particularly, the filtered digital picture signals coming from the first filter is stored in the first SRAM 51. The filtered digital picture signals coming from the second filter is stored in the second SRAM 52. The filtered digital picture signals coming from the third filter is stored in the third SRAM 53. The filtered digital picture signals coming from the fourth filter is stored in the fourth SRAM 54.

In block S07, the FPGA 40 converts the filtered digital picture signals coming from each filter into converted digital picture signals indicative of a plane image. Thus, the fish-eye image captured by each of the plurality of cameras can be converter to the plane image.

In block S08, the FPGA 40 combines the converted digital picture signals coming from the plurality of cameras to get a panorama image which provides a 360° view around the vehicle. The fish-eye images capture by the plurality of cameras have overlapping areas. In this combining step, the FPGA 40 takes average data of the overlapping areas.

In block S09, the FPGA 40 sends combined digital picture signals indicative of the panorama image to the D/A converting module 70.

In block S10, the D/A converting module 70 converts the combined digital picture signals to combined analog picture signals and sends the combined analog picture signals to the monitor 80.

In block S11, the monitor 80 displays the panorama image.

While the present disclosure has been illustrated by the description of embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, any indication used is only to be viewed for identification purposes and not as a suggestion as to an order for the steps.

What is claimed is:

1. A driving assistant system comprising:
a plurality of cameras configured to capture images around a vehicle, the plurality of cameras comprising a first camera attached to a front central portion of the vehicle, a second camera attached to a first rearview mirror of the vehicle, a third camera attached to a second rearview mirror of the vehicle, and a fourth camera attached to a rear central portion of the vehicle;
a monitor capable of displaying the images; and
a Field-Programmable Gate Array (FPGA) connected to the plurality of cameras, wherein the FPGA combines the images into a panorama image and sends the panorama image to the monitor to display the panorama image.

2. The driving assistant system of claim 1, further comprising an analog-to-digital (A/D) converting module connected to the plurality of cameras and the FPGA, wherein each of the images comprises analog picture signals, the A/D converting module comprises a plurality of A/D converters, and each of the plurality of A/D converters converts analog picture signals coming from a corresponding one of the plurality of cameras to digital picture signals.

3. The driving assistant system of claim 2, further comprising a filtering module connected to the A/D converting module, wherein the filtering module comprises a plurality of filters, each of the plurality of filters digital picture signals output from a corresponding one of the plurality of A/D converters and sends the filtered digital picture signals to the FPGA.

4. The driving assistant system of claim 1, further comprising a plurality of static random access memories and a dynamic random access memory connected to the FPGA to help the FPGA to store static and dynamic data.

5. The driving assistant system of claim 4, wherein the plurality of static random access memories comprises a first SRAM configured to store image signals coming from the first camera, a second SRAM configured to store image signals coming from the second camera, a third SRAM configured to store image signals coming from the third camera, and a fourth SRAM configured to store image signals coming from the fourth camera.

6. The driving assistant system of claim 1, wherein each of the plurality of cameras is a wide-angle lens camera capturing a fish-eye image, and the FPGA is capable of converting the fish-eye image to a plane image.

7. The driving assistant system of claim 6, wherein each of the plurality of cameras is a 170 degrees lens infrared camera.

8. A driving assistant method, comprising following steps:
utilizing a plurality of cameras to capture images around a vehicle in different positions and directions; the plurality of cameras comprising a first camera attached to a front central portion of the vehicle, a second camera attached to a first rearview mirror of the vehicle, a third camera attached to a second rearview mirror of the vehicle, and a fourth camera attached to a rear central portion of the vehicle;
combining the images into a panorama image by a Field-Programmable Gate Array (FPGA); and
displaying the panorama image which shows traffic conditions around the vehicle.

9. The driving assistant method of claim 9, wherein each of the images is a fish-eye image, and the FPGA is converts the fish-eye image into a plane image before combining the images.

10. The driving assistant method of claim 10, further comprising utilizing a analog-to-digital (A/D) converting module to convert analog picture signals of the image to digital picture signals before converting the fish-eye image.

11. The driving assistant method of claim 10, wherein the A/D converting module comprises a plurality of A/D converters, and each of the plurality of A/D converters is capable of converting analog picture signals coming from a corresponding one of the plurality of cameras to digital picture signals.

12. The driving assistant method of claim 11, further comprising filtering the digital picture signals and sending the filtered digital picture signals to the FPGA.

13. The driving assistant method of claim 12, wherein the panorama image shows traffic conditions completely around the vehicle.
